(19) United States
(12) Patent Application Publication
(10) Pub. No.: US 2005/0266341 A1
(43) Pub. Date: Dec. 1, 2005

(54) Photosensitive resin composition and LCD using the same

(75) Inventors: Dong Seok Kim, Daejeon-city (KR); Yong Sik Ahn, Seoul (KR); Kyungjun Kim, Daejeon-city (KR); Seung Hee Lee, Seoul (KR); Il Eok Kwon, Seoul (KR)

Correspondence Address: MCKENNA LONG & ALDRIDGE LLP, 1900 K STREET, NW, WASHINGTON, DC, 20006, US

(73) Assignee: LG CHEM, LTD. (Prosecution), Seoul (KR)

(21) Appl. No.: 11/138,355

(22) Filed: May 27, 2005

(30) Foreign Application Priority Data
May 31, 2004 (KR) 10-2004-0039211

(51) Int. Cl. G03C 1/492

(52) U.S. Cl. 430/270.1

(57) ABSTRACT

A photosensitive resin composition includes: a copolymer of an unsaturated carboxylic acid and a compound with unsaturated ethylenic bonds; an acrylate multi-functional monomer; a phenolic compound; a photopolymerization initiator; and an organic solvent. The photosensitive resin composition according to the present invention has superior resolution and development property because of enlarged solubility differentiation between exposed and unexposed region. The photosensitive resin composition can be effectively used for a transparent protective layer, an insulating layer, a passivation layer, a patterned spacer, etc., for LCDs.

### CROSS-REFERENCE TO RELATED PATENT APPLICATIONS

This application claims the benefit of Korean Patent Application No. 10-2004-0039211, filed on May 31, 2004, in the Korean Intellectual Property Office, the disclosure of which is incorporated herein in its entirety by reference.

### BACKGROUND OF THE INVENTION

1. Field of the Invention

The present invention relates to a photosensitive resin composition, and more particularly, to a negative type photosensitive resin composition with superior resolution and developing characteristics, and a liquid crystal display (LCD) manufactured using the same.

2. Description of the Related Art

In the manufacturing of LCDs, an inorganic protective layer formed of, for example, silicon nitride has been used to protect and insulate a thin film transistor (TFT) circuit. However, the inorganic protective layer has a relatively large dielectric constant of 6˜8, thus cannot be used for high aperture ratio LCD device. As a result, the demand for an organic insulating layer having a small dielectric constant is increasing. Among such organic insulating materials, a photosensitive resin that can be developed using an alkali solution is preferred for various purposes because of simple and low cost process.

Photosensitive resin refers to a resin whose solubility varies in a particular solution as a result of chemical reaction occurring when exposed to activation light such as ultraviolet light. A photosensitive resin which becomes (partially) insoluble after being exposed to light is referred to as “negative type”, and a photosensitive resin which becomes (partially) soluble after being exposed to light is referred to as “positive type”. In general, a photosensitive resin composition that can be developed using an alkali solution contains: a) a binder resin which is soluble in an alkali solution; b) a crosslinking compound having at least two unsaturated ethylenic bonds in its molecular structure; c) a photopolymerization initiator; and d) a solvent which dissolves each of the other components. The photosensitive resin composition may further contain a dye, a pigment, or various additives that can improve film formability and adhesion to a substrate.

Common binder resin that dissolves or expands in an alkali solution includes a carboxylic acid, an anhydrous carboxylic acid, a hydroxy group, an amino group, or an amide group in its polymeric chain structure. In particular, a Novolak phenol resin or an acrylic resin homopolymer or copolymer is widely used as such binder resin. Acrylic binder resin is most widely used for a TFT protective layer due to its superior transparency in visible wavelength region.

U.S. Pat. No. 4,139,391 discloses a photosensitive resin composition prepared by using a copolymer of acrylic acid compound and acrylate compound as a binder resin and an acrylate compound as a multi-functional monomer. However, solubility difference between exposed and unexposed portion of the photosensitive layer composition is not large enough to lead to sufficient development margin. In addition, the binder resin, which should remain intact throughout a development process, partially dissolves in a developing solution so that a fine pattern with 15 microns or less cannot be obtained. To prevent this phenomenon, a crosslinking compound can be used. However, if the amount of a crosslinking compound is excessive, a resulting film tends to be sticky, leading to processing capability reduction and increased particle contamination. In addition, exposure dose has to be increased to induce sufficient crosslinking reactions, thereby lowering productivity. Furthermore, the solubility of both exposed and unexposed portion decreases simultaneously so that the resolution of the composition is limited.

### SUMMARY OF THE INVENTION

The present invention provides a photosensitive resin composition with superior resolution and development characteristics due to its ability to lead to a maximum difference in solubility between exposed and unexposed portion.

The present invention also provides a liquid crystal display manufactured using the photosensitive resin composition.

According to an aspect of the present invention, there is provided a photosensitive resin composition comprising: a copolymer of an unsaturated carboxylic acid and a compound with unsaturated ethylenic bonds; an acrylate multi-functional monomer; a phenolic compound; a photopolymerization initiator; and an organic solvent.

The unsaturated carboxylic acid in the copolymer may be any compound with a radically polymerizable unsaturated bond and a carboxylic acid group that is soluble in a developer solution. Representative examples of such an unsaturated carboxylic acid include acrylic acid, methacrylic acid, maleic acid, fumaric acid, itaconic acid, a mixture of the forgoing acids, etc.

The compound with unsaturated ethylenic bonds, which comprises the other part of the copolymer, may be any compound that can be radically polymerized with the unsaturated carboxylic acid. Representative examples of such compounds with unsaturated ethylenic bonds include methyl(meth)acrylate, ethyl(meth)acrylate, n-butyl(meth)acrylate, t-butyl(meth)acrylate, cyclohexyl(meth)acrylate, dicyclopentanyl(meth)acrylate, dicyclopentanyloxyethyl(meth)acrylate, 2-hydroxyethyl(meth)acrylate, 2-hydroxypropyl(meth)acrylate, styrene, α-methylstyrene, p-methoxystyrene, acrylonitrile, glycidyl(meth)acrylate, glycidyl α-ethylacrylate, 3,4-epoxybutyl(meth)acrylate, 4,5-epoxy(cyclo)pentyl(meth)acrylate, 5,6-epoxy(cyclo)hexyl(meth)acrylate, 6,7-epoxy(cyclo)heptyl(meth)acrylate, benzyl(meth)acrylate, a mixture of the forgoing compounds, etc.

The acrylate multi-functional monomer may be a compound with at least two radically crosslinkable unsaturated bonds in its molecular structure. Representative examples of such an acrylate multi-functional monomer include ethyleneglycol di(meth)acrylate, 1,6-hexanediol di(meth)acrylate, polypropyleneglycol di(meth)acrylate, tetraethyleneglycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, a mixture of the forgoing compounds, etc.

The phenolic compound may be an aromatic compound having at least one phenolic hydroxy group in its molecular structure. Representative examples of such a phenolic compound include, but are not limited to, phenol and oligomer thereof, cresol and oligomer thereof, 4,4′-dihydroxydiphenylmethane, 4,4′-dihydroxydiphenyl ether, 2,2-bis(4-hydroxyphenyl)propane, tris(4-hydroxyphenyl)methane, 1,1-bis(4-hydroxyphenyl)-1-phenylethane, 1,1,1-tris(4-hydroxyphenyl)ethane, 1,3-bis[1-(4-hydroxyphenyl)-1-methylethyl]benzene, 1,4-bis[1-(4-hydroxyphenyl)-1-methylethyl]benzene, 4,4′-dihydroxybenzophenone, 2,4-dihydroxybenzophenone, 2,3,4-trihydroxybenzophenone, 2,4,6-trihydroxybenzophenone, 2,3,4,4′-tetrahydroxybenzophenone, spirobisindane, polyhydroxystyrene, and a copolymer of the forgoing compounds, a phenol/formaldehyde condensed Novolak resin, cresol/formaldehyde condensed Novolak resin, phenol-naphthol/formaldehyde condensed Novolak resin, etc.

The copolymer may have a weight average molecular weight of 3,000-100,000.

The amount of the acrylate multi-functional monomer may be in a range of 10-200 parts by weight based on 100 parts by weight of the solid content of the binder resin.

The amount of the phenolic compound may be in a range of 1-100 parts by weight based on 100 parts by weight of the solid content of the binder resin.

The amount of the photopolymerization initiator may be in a range of 0.5-50 parts by weight based on 100 parts by weight of the solid content of the binder resin.

According to another aspect of the present invention, there is provided a photosensitive transparent protective layer, an insulating layer, a passivation layer, a patterned spacer, or a liquid crystal display comprising the forgoing members. All of these are formed using the above-described photosensitive resin composition according to the present invention.

### BRIEF DESCRIPTION OF THE DRAWINGS

The above and other features and advantages of the present invention will become more apparent by describing in detail exemplary embodiments thereof with reference to the attached drawings in which:

FIG. 1 is an optical microscopic photograph of a pattern obtained using a photosensitive resin composition prepared in Example 2; and

FIG. 2 is an optical microscopic photograph of a pattern obtained using a photosensitive resin composition prepared in Comparative Example 1.

### DETAILED DESCRIPTION OF THE INVENTION

A photosensitive resin composition according to the present invention includes: a copolymer of an unsaturated carboxylic acid and a compound with unsaturated ethylenic bonds; an acrylate multi-functional monomer; a phenolic compound; a photopolymerization initiator; and an organic solvent. The copolymer forms a layer acting as a support before photoreaction and maintains the thickness of the layer constant.

The copolymer may be prepared by radical polymerization of an unsaturated carboxylic acid and a compound with unsaturated ethylenic bonds using a polymerization initiator in solvent.

The unsaturated carboxylic acid may be any compound with a radically polymerizable unsaturated bond and a carboxylic acid group that is soluble in a developer solution. Representative examples of such an unsaturated carboxylic acid include acrylic acid, methacrylic acid, maleic acid, fumaric acid, itaconic acid, a mixture of the forgoing acids, etc. Acrylic acid or methacrylic acid is preferred due to its high reactivity in copolymerization and the ease of getting monomers.

The content of the unsaturated carboxylic acid in the copolymer used in the present invention may be in a range of 5˜60% by mole. If the content of the unsaturated carboxylic acid is less than 5% by mole, patterns cannot be properly formed by a developer solution. If the content of the unsaturated carboxylic acid exceeds 60% by mole, patterns may be lost during development process.

The compound with unsaturated ethylenic bonds may be any compound that can be radically polymerized with the unsaturated carboxylic acid monomer.

In general, the compound with unsaturated ethylenic bonds is an acrylate compound. Examples of such compounds include methyl(meth)acrylate, ethyl(meth)acrylate, n-butyl(meth)acrylate, t-butyl(meth)acrylate, cyclohexyl(meth)acrylate, dicyclopentanyl(meth)acrylate, dicyclopentanyloxyethyl(meth)acrylate, 2-hydroxyethyl(meth)acrylate, 2-hydroxypropyl(meth)acrylate, glycidyl(meth)acrylate, glycidyl α-ethylacrylate, 3,4-epoxybutyl(meth)acrylate, 4,5-epoxy(cyclo)pentyl(meth)acrylate, 5,6-epoxy(cyclo)hexyl(meth)acrylate, 6,7-epoxy(cyclo)heptyl(meth)acrylate, benzyl(meth)acrylate, etc. In addition to the forgoing compounds, styrene, α-methylstyrene, p-methoxystyrene, acrylonitrile, and a mixture of these compounds can be used. Among these compounds, styrene and benzyl(meth)acrylate are preferred in view of copolymerization efficiency.

Examples of solvents that can be used to prepare the copolymer include: alcohols, such as methanol, ethanol, etc.; ethers, such as tetrahydrofuran, ethyleneglycol monomethylether, ethyleneglycol monoethylether, ethyleneglycol dimethylether, ethyleneglycol diethylether, propyleneglycol monomethylether, propyleneglycol monoethylether, propyleneglycol dimethylether, propyleneglycol diethylether, diethyleneglycol monomethylether, diethyleneglycol monoethylether, diethyleneglycol dimethylether, diethyleneglycol methylethylether, diethyleneglycol diethylether, etc.; esters, such as methylcellosolve acetate, ethylcellosolve acetate, propyleneglycol methylether acetate, propyleneglycol ethylether acetate, propyleneglycol propylether acetate, propyleneglycol butylether acetate, ethyl acetate, propyl acetate, butyl acetate, 3-methoxybutyl acetate, methyl 2-methoxypropionate, ethyl 2-methoxypropionate, propyl 2-methoxypropionate, butyl 2-methoxypropionate, methyl 3-methoxypropionate, ethyl 3-methoxypropionate, propyl 3-methoxypropionate, butyl 3-methoxypropionate, methyl 3-ethoxypropionate, ethyl 3-ethoxypropionate, propyl 3-ethoxypropionate, butyl 3-ethoxypropionate, etc.; ketones, such as methylethylketone, methylisobutylketone, cyclohexanone, etc.; and aromatic hydrocarbons, such as toluene.

Examples of the radical polymerization initiator that can be used in the preparation of the copolymer include azo compounds, such as 2,2-azobis(isobutyronitrile), 2,2-azobis(2,4-dimethylvaleronitrile), etc., organic peroxides, such as benzoyl peroxide, lauryl peroxide, t-butyl peroxypivalate, etc. These examples of radical polymerization initiators may be used individually or in combination of at least two.

The copolymer may have a weight average molecular weight (Mw) in a range of 3,000-100,000. If the copolymer has a weight average molecular weight smaller than 3,000, the film forming property and thermal resistance of the composition degrade. If the copolymer has a weight average molecular weight larger than 100,000, the development characteristics of the composition in developer solution and degree of planarization tend to degrade.

When preparing a copolymer used in the present invention, reaction components, i.e., monomers and a radical polymerization initiator, may be added all at once. Alternatively, after adding a minimum quantity of each of the reaction components, the remaining quantity of each of the reaction components may be added continuously or in a stepwise manner. Polymerization temperature depends on the kind of the radical polymerization initiator used, but in general, lies in the range of 60° C.˜80° C. Either continuous or batch polymerization is possible, preferably in an oxygen-free atmosphere. Conditions for polymerization, such as reaction temperature, agitation rate, etc., may be appropriately varied during the reaction.

An acrylate multi-function monomer used in the photocurable resin composition according to the present invention distributes uniformly with binder resin in the composition and becomes crosslinked when exposed to light, such as UV light, thus forms a network structure. The crosslinked network structure prevents the alkali soluble resin from being dissolved in developer solution and being flushed out during the development process.

Examples of the acrylate multi-function monomer that can be used in the present invention include ethyleneglycol di(meth)acrylate, 1,6-hexanediol di(meth)acrylate, polypropyleneglycol di(meth)acrylate, tetraethyleneglycol di(meth)acrylate, trimethylol propane tri(meth)acrylate, pentaerythritol tri(meth)acrylate, pentaerythritol tetra(meth)acrylate, dipentaerythritol penta(meth)acrylate, dipentaerythritol hexa(meth)acrylate, etc., which can be used individually or in combination of at least two.

The amount of the acrylate multi-functional monomer may be in the range of 10-200 parts by weight based on 100 parts by weight of the solid content of the binder resin. If the amount of the acrylate multi-functional monomer is less than 10 parts by weight, crosslinking is insufficient and even the exposed portion dissolves. If the amount of the acrylate multi-functional monomer exceeds 200 parts by weight, the productivity falls down due to increased exposure dose, and the solubility of the unexposed portion decreases which leads to inferior resolution of the photoresist.

A phenolic compound that can be used in the present invention is soluble in an alkali developer solution and has compatibility with other components of the photosensitive resin composition. The phenolic compound improves the resolution of the photosensitive resin composition by increasing the solubility of the unexposed portion. Such phenolic compound is also present in the exposed portion but cannot affect the solubility because that part is already crosslinked before development.

The phenolic compound may be an aromatic compound having at least one phenolic hydroxy group in its molecular structure. Representative examples of such a phenolic compound include, but are not limited to, phenol and oligomer thereof, cresol and oligomer thereof, 4,4′-dihydroxydiphenylmethane, 4,4′-dihydroxydiphenylether, 2,2-bis(4-hydroxyphenyl)propane, tris(4-hydroxyphenyl)methane, 1,1-bis(4-hydroxyphenyl)-1-phenylethane, 1,1,1-tris(4-hydroxyphenyl)ethane, 1,3-bis[1-(4-hydroxyphenyl)-1-methylethyl]benzene, 1,4-bis[1-(4-hydroxyphenyl )-1-methylethyl]benzene, 4,4′-dihydroxybenzophenone, 2,4-dihydroxybenzophenone, 2,3,4-trihydroxybenzophenone, 2,4,6-trihydroxybenzophenone, 2,3,4,4′-tetrahydroxybenzophenone, spirobisindane, polyhydroxystyrene, and a copolymer of the forgoing compounds, a phenol/formaldehyde condensed Novolak resin, cresol/formaldehyde condensed Novolak resin, phenol-naphthol/formaldehyde condensed Novolak resin, etc.

The amount of the phenolic compound may be in the range of 1-100 parts by weight based on 100 parts by weight of the solid content of the binder resin. If the amount of the phenolic compound is less than 1 part by weight, contribution to the resolution enhancement is negligible. If the amount of the phenolic compound exceeds 100 parts by weight, pattern shape tends to become uneven and pattern adhesion to the substrate is weak.

Any photopolymerization initiator commonly used in the field can be used in the photosensitive resin composition according to the present invention without limitation. Examples of such a photopolymerization initiator include biimidazole compounds, benzoin compounds, triazine compounds, acetophenone compounds, benzophenone compounds, azo compounds, etc. Specified examples of photopolymerization initiator include 2,2-bis(2-chlorophenyl)-4,4,5,5-tetraphenyl-1,2-biimidazole, 2,2-bis(2,4-dichlorophenyl)-4,4,5,5-tetraphenyl-1,2-biimidazole, 2,2-bis(2,4,6-trichlorophenyl)-4,4,5,5-tetraphenyl-1,2-biimidazole, 2,4,6-tris(trichloromethyl)-s-triazine, 2-methyl-4,6-bis(trichloromethyl)-s-triazine, benzophenone, 4,4′-bis(N,N-diethylamino)benzophenone, 4,4′-bis(N,N-dimethylamino)benzophenone, phenylbiphenylketone, 1-hydroxy-1-benzoylcyclohexane, benzil, benzil dimethylketal, 2-benzyl-2-(dimethylamino)-4′-morpholinobutyrophenone, 2-methyl-4′-(methylthio)-2-morpholinopropiophenone, thioxanthone, 1-chloro-4-propoxythioxanthone, isopropylthioxanthone, diethylthioxanthone, ethylanthraquinone, 4-benzoyl-4′-methyldiphenylsulfide, benzoin butylether, 2-hydroxy-2-benzoylpropane, 2-hydroxy-2-(4′-isopropyl)benzoylpropane, 4-butylbenzoyltrichloromethane, 4-phenoxybenzoylchloromethane, methyl benzoylformate, 1,7-bis(9′-acridinyl)heptane, 9-n-butyl-3,6-bis(2′-morpholino-isobutyroyl)carbazole, 2,4,6-trimethylbenzoyidiphenylphosphineoxide, etc.

The amount of the photopolymerization initiator may be in the range of 0.5-50 parts by weight based on 100 parts by weight of the solid content of the binder resin. If the amount of the photopolymerization initiator is less than 0.5 parts by weight, crosslinking is not enough to cause network structure. If the amount of the photopolymerization initiator exceeds 50 parts by weight, color of the coated layer turns yellowish and more exposure energy is required. Sometimes even photopolymerization initiator tends to aggregate on the surface of the coated layer after bake.

Solvent in the photosensitive resin composition according to the present invention is not specifically limited as long as it is commonly used in the field. Examples of such solvent include acetone, methylethylketone, methylisobutylketone, methylcellosolve, ethylcellosolve, tetrahydrofuran, 1,4-dioxane, ethyleneglycol dimethylether, ethyleneglycol duethylether, propyleneglycol dimethylether, propyleneglycol diethylether, chloroform, methylene chloride, 1,2-dichloroethane, 1,1,1-trichloroethane, 1,1,2-trichloroethane, trichloroethene, 1,2,3-trichloropropane, hexane, heptane, octane, cyclopentane, cyclohexane, benzene, toluene, xylene, methanol, ethanol, isopropanol, propanol, butanol, t-butanol, propyleneglycol monomethylether, propyleneglycol monoethylether, propyleneglycol monopropylether, propyleneglycol monobutylether, dipropyleneglycol dimethylether, dipropyleneglycol diethylether, dipropyleneglycol monomethylether, methyl carbitol, ethyl carbitol, propyl carbitol, butyl carbitol, cyclopentanone, cyclohexanone, propyleneglycol methylether acetate, propyleneglycol ethylether acetate, propyleneglycol methylether propionate, 3-methoxybutyl acetate, 3-methyl-3-methoxybutyl acetate, ethyl-3-ethoxypropionate, ethylcellosolve acetate, methylcellosolve acetate, butyl acetate, propyl acetate, ethyl acetate, etc., which may be used individually or in combination of at least two.

In addition to the above-described components, the photosensitive resin composition according to the present invention may further include a thermal polymerization inhibitor, such as hydroquinone, 4-methoxyphenol, quinone, pyrocatechol, t-butylcatechol, phenothiazine, etc., a plasticizer, a silane coupling agent, a filler, a surfactant, etc., which are commonly used additives in coating technology.

Hereinafter, a method of forming a pattern using an alkali developable, high-resolution, negative photosensitive resin composition according to the present invention will be described.

The photosensitive resin composition is coated on a substrate. In general, a substrate made of glass or transparent plastic resin is used for the substrate in consideration of the features of liquid crystal displays. However, substrate is not specially limited provided that the purpose of liquid crystal display is fulfilled. The photosensitive resin composition according to the present invention may be coated on a surface of the substrate using various coating method such as spraying, roll coating, slit nozzle coating, rotary coating, extrusion coating, bar coating, etc. Combination of the above-listed coating methods is possible. The thickness of the coated layer varies depending on the coating method, solid content and viscosity of the composition, etc. Typical thickness of the coated layer is controlled to be 0.5˜100 μm after drying. Prebake process is performed after coating the composition using vacuum, infrared rays, or/and heat to remove solvent and fix solid components on the substrate. Prebake condition varies according to the kinds or amounts of the components. Typically in LCD process, heating may be performed at 60˜130° C. for 5˜500 seconds when using a hot plate, and at 60˜140° C. for 20˜1000 seconds using an oven. Next, the coated layer is irradiated through a patterned mask. Examples of such exposure light source include far UV, UV, visible light, electron beam, X-ray, etc. G-line (436 nm), i-line (365 nm), or h-line (405 nm) from mercury lamp is preferred in the present invention. Exposure mode can be appropriately selected among contact, proximity, or projection type.

After the exposure, post-exposure bake (PEB) can be added before development, if necessary. PEB may be performed at 150° C. or lower for 0.1˜10 minutes.

In development process, the unexposed portion of the layer is removed using an aqueous alkali developer solution. Alkali developer solution that can be used in the present invention may include: inorganic alkaline materials, such as sodium hydroxide, potassium hydroxide, sodium carbonate, sodium silicate, sodium metasilicate, ammonia, etc; primary amines, such as ethylamine, n-propylamine, etc.; secondary amines, such as diethylamine, n-propylamine, etc.; tertiary amines, such as triethylamine, methyldiethylamine, n-methylpyrrolidone, etc.; alcohol amines, such as dimethyl(hydroxyethyl)amine, tris(hydroxyethyl)amine, etc.,; quaternary ammonium salts, such as tetramethylammonium hydroxide, tetraethylammonium hydroxide, choline, etc.; and amines, such as pyrrole, piperine, etc., It is also possible to add into such an aqueous alkali developer solution a water-soluble organic solvent, such as methyl alcohol, ethyl alcohol, propyl alcohol, isopropyl alcohol, propyleneglycol monomethyl ether, dipropyleneglycol monomethyl ether, etc., or a surfactant in an appropriate amount. Typical development time is 10˜200 seconds using dipping, spraying, puddling, etc.

After development, the substrate is washed with deionized (DI) water for 20˜200 seconds and dried using compressed air or nitrogen to give pattern on the substrate. Patterns on the substrate are further heate-treated and hardened by postbake (sometimes called hardbake) using a heating apparatus, for example, a hot plate or an oven, to enhance the heat and chemical resistance of the pattern. Postbake may be performed at 150° C.˜300° C. for 1˜120 minutes when using a hot plate or for 10˜120 minutes in an oven. After postbake, a fully cross-liked pattern is obtained.

This heat-resistant pattern formed from the negative type photosensitive resin composition according to the present invention can be used for various purposes, for example, as a protective layer, an insulating layer, an organic passivation, a patterned spacer, etc., for LCDs.

Hereinafter, the present invention will be described in more detail with reference to the following examples. However, these examples are merely illustrative and are not intended to limit the scope of the invention.

### EXAMPLE 1

1-(1). Synthesis of Copolymer

250 g of 3-methoxybutyl acetate and 10 g of 2,2-azobis(dimethylvaleronitrile) were put into a flask with a condenser and a stirrer under nitrogen atmosphere. Next, 80 g of benzyl methacrylate and 20 g of methacrylic acid were sequentially added. The temperature of the solution was elevated to 70° C. under stirring and maintained for 6 hours to obtain a copolymer having Mw of 12,000.

1-(2). Preparation of Photosensitive Resin Composition

33 parts by weight of the copolymer solution in Example 1-(1), 10 parts by weight of dipentaerythritol hexaacrylate as a multi-functional monomer, 2 parts by weight of 2,2-bis(4-hydroxyphenyl)propane as a phenolic compound, 2 parts by weight of 2-methyl-4′-(methylthio)-2-morpholinopropiophenone as a photopolymerization initiator, and 53 parts by weight of propylene glycol monomethyl ether acetate were thoroughly mixed and dissolved using a stirrer. The resulting solution was filtered through a 0.2-micron filter to obtain a phototosensitive resin composition.

### EXAMPLE 2

Preparation of Photosensitive Resin Composition

A photosensitive resin composition was prepared in the same manner as in Example 1, except that 1,1,1-tris(4-hydroxyphenyl)ethane was used as a phenolic compound instead of 2,2-bis(4-hydroxyphenyl)propane.

### EXAMPLE 3

Preparation of Photosensitive Resin Composition

A photosensitive resin composition was prepared in the same manner as in Example 1, except that polyhydroxystyrene having Mw of 11,000 was used as a phenolic compound instead of 2,2-bis(4-hydroxyphenyl)propane.

### EXAMPLE 4

4-(1). Synthesis of Copolymer

250 g of 3-methoxybutyl acetate and 10 g of 2,2-azobis(dimethylvaleronitril) 10 g were put into a flask with a condenser and a stirrer under nitrogen atmosphere. Next, 80 g of benzyl methacrylate and 20 g of acrylic acid were sequentially. The temperature of the solution was elevated to 70° C. under stirring and maintained for 6 hours to obtain a copolymer having Mw of 10,000.

4-(2). Preparation of Photosensitive Resin Composition

33 parts by weight of the prepared copolymer solution in Example 4-(1), 10 parts by weight of dipentaerythritol hexaacrylate as a multi-functional monomer, 2 parts by weight of 2,2-bis(4-hydroxyphenyl)propane as a phenolic compound, 2 parts by weight of 2-methyl-4′-(methylthio)-2-morpholinoropiophenone as a photopolymerization initiator, and 53 parts by weight of propylene glycol monomethyl ether acetate were thoroughly mixed and dissolved using a stirrer. The resulting solution was filtered through a 0.2-micron filter to obtain a phototosensitive resin composition.

### EXAMPLE 5

5-(1). Synthesis of Copolymer

250 g of 3-methoxybutyl acetate and 10 g of 2,2-azobis(dimethylvaleronitril) were put into a flask with a condenser and a stirrer under nitrogen atmosphere. Next, 80 g of benzyl methacrylate, 20 g of methacrylic acid, and 20 g of glycidyl methacrylate were sequentially added. The temperature of the solution was elevated to 70° C. under stirring and maintained for 6 hours to obtain a copolymer having Mw of 14,000.

5-(2). Preparation of Photosensitive Resin Composition

33 parts by weight of the prepared copolymer solution in Example 5-(1), 10 parts by weight of dipentaerythritol hexaacrylate as a multi-functional monomer, 2 parts by weight of 2,2-bis(4-hydroxyphenyl)propane as a phenolic compound, 2 parts by weight of 2-methyl-4′-(methylthio)-2-morpholinopropiophenone as a photopolymerization initiator, and 53 parts by weight of propylene glycol monomethyl ether acetate were thoroughly mixed and dissolved using a stirrer. The resulting solution was filtered through a 0.2-micron filter to obtain a phototosensitive resin composition.

### EXAMPLE 6

6-(1). Synthesis of Copolymer

360 g of the copolymer solution synthesized in Example 1-(1) was put into a flask with a stirrer and a nitrogen inlet, and heated to 110° C. Next, 10 g of glycidyl methacrylate was slowly added into the flask for 1 hour and allowed to react completely until no epoxy group remained to obtain a copolymer having Mw of 11,000.

6-(2). Preparation of Photosensitive Resin Composition

33 parts by weight of the copolymer solution synthesized in 6-(1), 10 parts by weight of dipentaerythritol hexaacrylate as a multi-functional monomer, 2 parts by weight of 2,2-bis(4-hydroxyphenyl)propane as a phenolic compound, 2 parts by weight of 2-methyl-4′-(methylthio)-2-morpholinopropiophenone as a photopolymerization initiator, and 53 parts by weight of propylene glycol monomethyl ether acetate were thoroughly mixed and dissolved using a stirrer. The resulting solution was filtered through a 0.2-micron filter to obtain a phototosensitive resin composition.

### COMPARATIVE EXAMPLE 1

Preparation of Photosensitive Resin Composition

A photosensitive resin composition was prepared in the same manner as in Example 1, except that no phenolic compound was used.

### COMPARATIVE EXAMPLE 2

Preparation of Photosensitive Resin Composition

A photosensitive resin composition was prepared in the same manner as in Example 6, except that no phenolic compound was used.

### EXPERIMENTAL EXAMPLE 1

Measurement of Physical Properties

Each of the photosensitive resin compositions prepared in Examples 1˜6 and Comparative Examples 1˜2 was spin-coated on a glass substrate and prebaked on a hot plate at 100° C. for 100 seconds. The resulting coated layer was exposed to UV light with 365 nm wavelength and an intensity of 20 mW/cm² through a patterned mask placed thereon using a mask aligner (MA-8, Suss Microtech.). Exposure mode was proximity with 100 um gap between the layer and the mask. After development using 2.38% aqueous tetramethyl ammonium hydroxide at room temperature for 15 seconds, the substrate was washed with pure water for 20 seconds and heated in an oven at 220° C. for 30 minutes to cure the coated layer, thereby resulting in hole patterns with 3 μm thickness. Hole patterns are commonly used for a photosensitive passivation layer to connect metal line and ITO electrode in TFT.

The smallest hole size opened at a constant exposure dose (in this experiment, 200 mJ/cm²) was defined as the resolution of the composition. The results of measuring the resolutions of the photosensitive resin compositions are shown in Table 1 below.

Residual characteristics of the photosensitive resin compositions were measured by observing whether any portion that had to be washed out after development remained or not. The residual characteristics were defined as “good” if there was no residue, and as “poor” if there was. The results are also shown in Table 1.

TABLE 1

| | | Residual | |
|---|---|---|---|
| | Resolution (μm) | characteristic | Transmittance (%) |
| Example 1 | 15 | Good | 98 |
| Example 2 | 12 | Good | 98 |
| Example 3 | 12 | Good | 98 |
| Example 4 | 15 | Good | 98 |
| Example 5 | 15 | Good | 98 |
| Example 6 | 12 | Good | 97 |
| Comparative | 25 | Good | 98 |
| Example 1 | | | |
| Comparative | 25 | Poor | 97 |
| Example 2 | | | |

As is apparent from Table 1, the photosensitive resin compositions according to the present invention shows superior resolution of 12˜15 μm while compositions according to Comparative Example 1 and 2 shows resolution of 25 μm. In addition, the photosensitive resin compositions according to the present invention are residue-free while comparative example 2 has poor residual characteristic.

### EXPERIMENTAL EXAMPLE 2

Characteristics Comparison Using Optical Microscopy

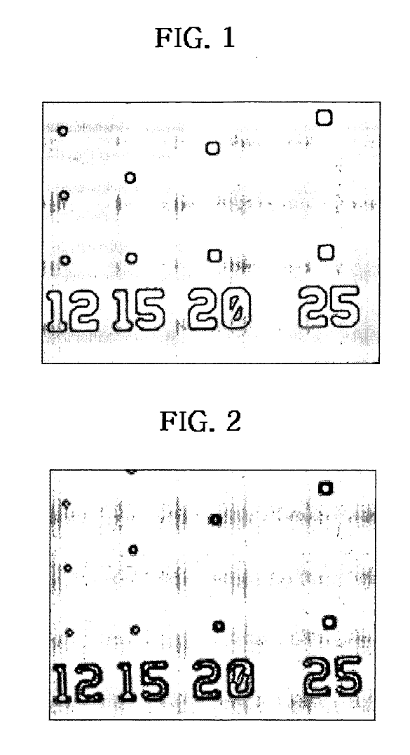

Optical microscopic pictures were taken for patterns obtained from each of the photosensitive resin compositions according to Example 2 and Comparative Example 1 and displayed in FIGS. 1 and 2. Resolutions and the residual characteristics were observed in each case. The patterns from the photosensitive resin composition in Example 2 are well defined without residue as illustrated in FIG. 1, as compared to those in Comparative Example 1 (FIG. 2). However, holes smaller than 25 μm were not defined when the photosensitive resin composition in Example 2 was used.

As described above, a photosensitive resin composition according to the present invention has superior resolution and development property because of enlarged solubility differentiation between exposed and unexposed region. In addition, the photosensitive resin composition according to the present invention can be effectively used as a transparent protective layer, an insulating layer, a passivation layer, a patterned spacer, etc., for LCDs.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A photosensitive resin composition comprising:
a copolymer of an unsaturated carboxylic acid and a compound with unsaturated ethylenic bonds;
an acrylate multi-functional monomer;
a phenolic compound;
a photopolymerization initiator; and
an organic solvent.

2. The photosensitive resin composition of claim 1, wherein the unsaturated carboxylic acid is one selected from the group consisting of acrylic acid, methacrylic acid, maleic acid, fumaric acid, itaconic acid, and a mixture of the forgoing acids.

3. The photosensitive resin composition of claim 1, wherein the compound with unsaturated ethylenic bonds is one selected from the group consisting of methyl(meth)acrylate, ethyl(meth)acrylate, n-butyl(meth)acrylate, t-butyl(meth)acrylate, cyclohexyl(meth)acrylate, dicyclopentanyl(meth)acrylate, dicyclopentanyloxyethyl(meth)acrylate, 2-hydroxyethyl(meth)acrylate, 2-hydroxypropyl(meth)acrylate, styrene, α-methylstyrene, p-methoxystyrene, acrylonitrile, glycidyl(meth)acrylate, glycidyl α-ethylacrylate, 3,4-epoxybutyl(meth)acrylate, 4,5-epoxy(cyclo)pentyl(meth)acrylate, 5,6-epoxy(cyclo)hexyl(meth)acrylate, 6,7-epoxy(cyclo)heptyl(meth)acrylate, benzyl(meth)acrylate, and a mixture of the forgoing compounds.

4. The photosensitive resin composition of claim 1, wherein the acrylate multi-functional monomer is one selected from the group consisting of ethyleneglycol di(meth)acrylate, 1,6-hexanediol di(meth)acrylate, polypropyleneglycol di(meth)acrylate, tetraethyleneglycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and a mixture of the forgoing compounds.

5. The photosensitive resin composition of claim 1, wherein the phenolic compound is one or a combination of at least two selected from the group consisting of phenol and an oligomer thereof, cresol and an oligomer thereof, 4,4′-dihydroxydiphenylmethane, 4,4′-dihydroxydiphenylether, 2,2-bis(4-hydroxyphenyl)propane, tris(4-hydroxyphenyl)methane, 1,1-bis(4-hydroxyphenyl)-1-phenylethane, 1,1,1-tris(4-hydroxyphenyl)ethane, 1,3-bis[1-(4-hydroxyphenyl)-1-methylethyl]benzene, 1,4-bis[1-(4-hydroxyphenyl)-1-methylethyl]benzene, 4,4′-dihydroxybenzophenone, 2,4-dihydroxybenzophenone, 2,3,4-trihydroxybenzophenone, 2,4,6-trihydroxybenzophenone, 2,3,4,4′-tetrahydroxybenzophenone, spirobisindane, polyhydroxystyrene, and a copolymer of the foregoing compounds, a phenol/formaldehyde condensed Novolak resin, cresol/formaldehyde condensed Novolak resin, and phenol-naphthol/formaldehyde condensed Novolak resin.

6. The photosensitive resin composition of claim 1, wherein the copolymer has a weight average molecular weight of 3,000-100,000.

7. The photosensitive resin composition of claim 1, wherein the amount of the acrylate multi-functional monomer is in the range of 10-200 parts by weight based on 100 parts by weight of the solid content of the binder resin.

8. The photosensitive resin composition of claim 1, wherein the amount of the phenolic compound is in the range of 1-100 parts by weight based on 100 parts by weight of the solid content of the binder resin.

9. The photosensitive resin composition of claim 1, wherein the amount of the photopolymerization initiator is in the range of 0.5-50 parts by weight based on 100 parts by weight of the solid content of the binder resin.

10. A photosensitive transparent protective layer, an insulating layer, a passivation layer, a patterned spacer, or a liquid crystal display comprising the forgoing members, wherein the photosensitive transparent protective layer, the insulating layer, the passivation layer, and the patterned spacer are formed using the photosensitive resin composition according to any one of claims 1 through 9.
